(19) United States
(12) Patent Application Publication
(10) Pub. No.: US 2011/0025235 A1
(43) Pub. Date: Feb. 3, 2011

(54) METHOD AND DEVICE FOR CONTROLLING THE POWER SUPPLY OF AN ELECTROMAGNETIC ACTUATOR

(76) Inventors: Fabrizio Marignetti, Napoli (IT); Giovanni Tomassi, Cassino (IT); Enzo De Santis, Fondi (IT)

Correspondence Address: DICKSTEIN SHAPIRO LLP, 1825 EYE STREET NW, Washington, DC, 20006-5403, US

(21) Appl. No.: 12/844,367

(22) Filed: Jul. 27, 2010

(30) Foreign Application Priority Data
Jul. 28, 2009 (IT) BO2009A000491

(51) Int. Cl. H02K 33/00

(52) U.S. Cl. 318/129

(57) ABSTRACT

In an electromagnetic actuator, which comprises a stator, a translator movable along a guiding element, and an excitation coil for generating an electromagnetic force which moves the translator, the coil is supplied with an electric current obtained according to the sum of a first electric signal, the time pattern of which defines a desired motion of the translator, with a second electric signal, which is generated only at each of given level variations of the first electric signal by modulating an oscillating function with a decreasing, time limited function, so that the second signal has an amplitude envelope having a certain maximum width such that the electromagnetic force is subjected to a higher increase of the static friction force between the translator and the guiding element.

The present invention relates to a method and device for controlling the power supply of an electromagnetic actuator.

### BACKGROUND OF THE INVENTION

In particular, the present invention is advantageously, but not exclusively applied to electromagnetic actuators for proportioning valves, also known as modulating solenoid valves, to which explicit reference will be made in the following description without therefore loosing in generality.

A proportioning or modulating solenoid valve comprises a valve and an electromagnetic actuator for moving the valve according to precise kinematic trajectories depending on a given power supply of the actuator.

The electromagnetic actuator of a proportioning solenoid valve comprises a fixed ferromagnetic core, also known as a stator or cladding, a movable ferromagnetic core, and an excitation winding or coil, which is integral with the fixed core and is adapted to generate, when electrically supplied, an electromagnetic induction field which produces an electromagnetic force tending to move the movable core with respect to the fixed core. The movable core is traditionally named translator or wiper if it performs translatory movements, or rotor if it performs rotational movements. The solenoid valve typically comprises an actuating mechanism of the valve kinematically connecting the valve to the movable core.

The electromagnetic actuator often comprises an elastic element to move and normally maintain the movable core, and thus the valve, in an end-of-travel position. In such a case, the electromagnetic force tends to contrast the bias of the elastic element to move the translator to one or more desired positions between the first end-of-travel position and a second end-of-travel position.

The electromagnetic actuator further comprises one or more guiding elements fixed to the stator to define the trajectory along which the movable core may move. The guiding elements are made of a material having a low friction coefficient with the surface of the movable core.

In a typical electromagnetic actuator for translatory movements, i.e. of the type comprising a translator movable along a longitudinal axis thereof, the elastic element consists, for example, of a helical spring coaxial with the translator and the latter slides within a tubular guiding element fixed to the stator and arranged inside the excitation coil. The guiding element is made of a material which has a low friction coefficient with the walls of the translator.

The dynamics of an electromagnetic actuator is governed by the second law of dynamics, which in the case of an electromagnetic actuator for translatory movements can be written as follows:

$${F}_{em} = m \cdot \frac{{d}^{2} x}{d {t}^{2}} + β \cdot \frac{d x}{d t} + k \cdot x + {F}_{r} + {F}_{a} ,$$

where Fₑₘ is the electromagnetic force generated by the excitation coil, x is the linear position of the translator, m is the mass of the translator, β is the viscosity coefficient of the medium in which the translator moves, k is the elasticity coefficient of the elastic element, Fᵣ is a resisting force and Fₐ is a friction force. The resisting force Fᵣ comprises, for example, the force generated by the pressure of a fluid acting on the valve, and thus on the translator. In the case of an electrometric actuator for rotational movements, dynamics is governed by a similar equation but written in terms of torques and with reference to an angular position of the translator.

The excitation coil is supplied by imposing an electric voltage (impressed voltage supply) or an electric current (impressed current supply). The power supply is typically obtained by amplifying a control signal, the time pattern of which is such to define a desired motion of the translator.

The power supply of the excitation coil creates attraction forces between the translator and the stator both in the movement direction of the translator and in the direction normal to the movement direction. The attraction forces normal to the movement direction increase the attraction force which is generated due to the contact between the surface of the guiding element and the surface of the translator.

In particular, the friction force which is created from the contact between two surfaces is a constraining reaction, which is either lower than or equal to the product of a friction coefficient by the normal force N to the two surfaces (Fₐ<=μ·N). The friction coefficient μ strongly varies in a non-linear manner with the relative speed between the contact surfaces. As shown by the graph in FIG. 1, the friction coefficient μ quickly decreases as the relative speed Vrel between the parts in contact increases, quickly passing from a high value for speeds close to zero (static friction, also known as stick-slip) to a low value already at slow speeds (dynamic friction).

Thus, despite the guiding element being made of a material which determines a relatively low friction coefficient between the guiding element and the translator, the friction force which is created by supplying the excitation coil may appreciably brake the translator. In particular, minor variations of the electromagnetic force may be totally compensated by the static friction force and thus not cause any movement of the translator. This behavior causes a series of problems. For example, if the electromagnetic actuator is controlled in open loop, such a behavior produces non-negligible positioning errors of the translator. Or if the electromagnetic actuator is controlled in closed loop, such a behavior produces overshooting of the movement of the translator in response to a specific control signal.

### SUMMARY OF THE INVENTION

It is an object of the present invention to provide a method and a device for controlling the power supply of an electromagnetic actuator for a proportioning solenoid valve, which method and device are free from the above-described drawbacks while being easy and cost-effective to be implemented.

In accordance with the present invention, a method and a device are provided to control the power supply of an electromagnetic actuator for a proportioning solenoid valve as defined in the attached claims.

### BRIEF DESCRIPTION OF THE DRAWINGS

For a better understanding of the present invention, a preferred embodiment will now be described by way of mere non-limiting example, and with reference to the accompanying drawings, in which:

FIG. 1 shows a graph depicting the friction coefficient between two surfaces in contact as the relative speed between the surfaces themselves varies;

FIG. 2 diagrammatically shows, partially in blocks, a proportioning solenoid valve comprising an electromagnetic actuator and a corresponding electronic control device implementing the control method according to the present invention;

FIG. 3 is a block diagram of a signal triggering block of the control device in FIG. 2;

FIG. 4 is a block diagram of a signal generating block within the control device in FIG. 2;

FIG. 5 shows an example of time pattern of a control signal supplied to the control device in FIG. 2 and of two signals generated by the control device in FIG. 2 according to the control signal; and

FIG. 6 shows a further example of time pattern of a control signal supplied to the control device in FIG. 2 and of two signals generated by the control device in FIG. 2 according to the control signal.

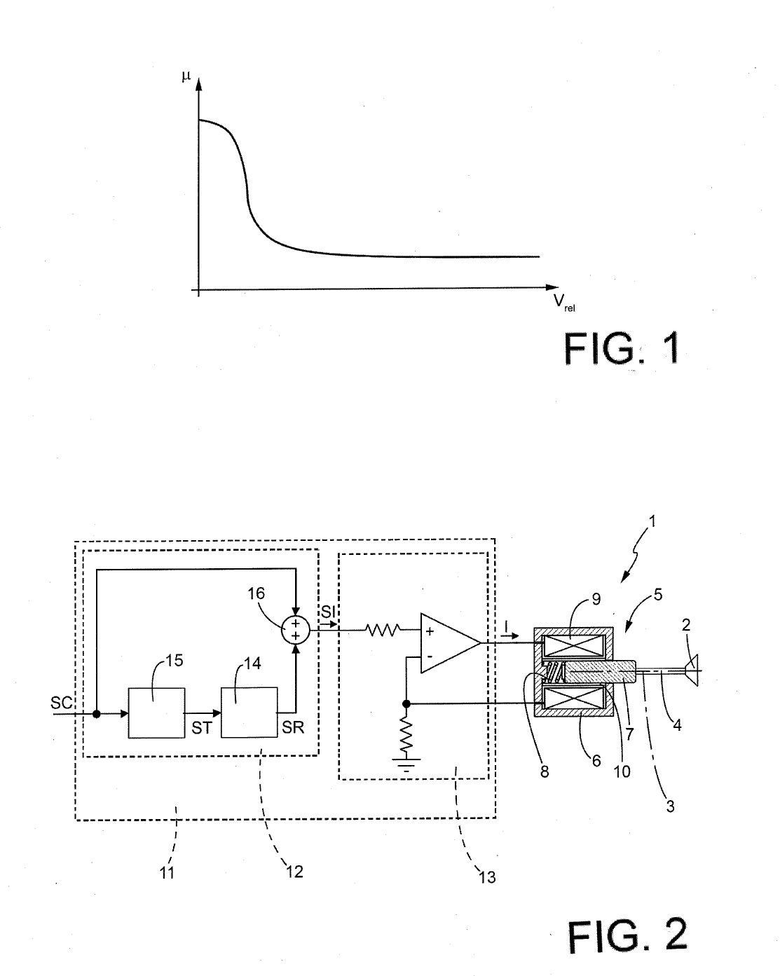

### DETAILED DESCRIPTION OF THE INVENTION

In FIG. 2, numeral 1 generally indicates a proportioning solenoid valve, shown in longitudinal section, comprising a general valve 2 movable along a longitudinal axis 3 thereof and capable of adjusting the flow rate or pressure of a fluid in a fluid-dynamic circuit (not shown), an actuating mechanism of the valve consisting, for example, of a rod 4 integral with the valve 2, and an electromagnetic actuator 5 for actuating the valve 2 by means of the rod 4.

The electromagnetic actuator 5 comprises a stator 6 made of ferromagnetic material, a translator 7 made of ferromagnetic material and movable with respect to the stator 6 between two end-of-travel positions along a rectilinear trajectory parallel to axis 3, an elastic element 8 for moving, and normally maintaining, the translator 7 in one of the end-of-travel positions, an electromagnetic excitation coil 9 for generating, when an appropriate power supply signal is supplied, an electromagnetic force such as to move the translator 7 against the bias of the elastic element 8, and a tubular guiding element 10 fixed to the stator 6 to define the trajectory along which the translator 7 may move.

The movement of translator 7 defines an air gap having a variable length, measured parallelly to axis 3. The translator 7 is movable between a first end-of-travel position, which corresponds to a maximum length of the air gap, and thus a maximum reluctance of the air gap, and a second end-of-travel position, which corresponds to the minimum length of the air gap, and thus a minimum reluctance of the air gap.

The elastic element 8 consists, for example, of a helical spring arranged in the air gap in a coaxial position with respect to the axis 3 to exert a mechanical force such as to move, and normally maintain, the translator 7 in the first end-of-travel position.

The coil 9 consists, for example, of a solenoid which is integrally accommodated inside the stator 6 so as to surround the translator 7 in a substantially coaxial manner with respect to the axis 3 in order to generate, when electrically supplied, an electromagnetic induction field which produces an electromagnetic force acting on the translator 7, so as to reduce the reluctance of the air gap. Therefore, the electromagnetic force is adapted to move the translator 7 towards the second end-of-travel position against the bias of the elastic element 8.

Impressed current is advantageously supplied to the coil 9, i.e. the power supply signal consists of an electric current signal I. The impressed current supply allows the electromagnetic actuator to have greater response rapidity and better operating linearity. The desired motion is imparted to the translator 7 by modulating the intensity of the electric current signal I according to an appropriate time pattern.

The guiding element 10 is arranged between coil 9 and translator 7 and is made of a material which has a low friction coefficient with the external surfaces of translator 7.

The electromagnetic actuator 5 is provided with an electronic control device 11 for controlling the power supply of the coil 9. The device 11 is constructed according to the invention as described below.

The device 11 comprises a control unit 12, adapted to receive a first electric signal SC, to internally generate a second electric signal SR according to the signal SC and to provide a third electric signal SI consisting of a sum of the signals SC and SR. Device 11 further comprises a power device 13 connected between the control unit 12 and the coil 9, to amplify the signal SI and correspondingly output the electric current signal I to be supplied to the coil 9.

The signal SC consists, for example, of an electric voltage signal, and may be either analogue or digital. If the electromagnetic actuator 5 is controlled in open loop, the signal SC is a position reference signal of the translator 7. If, instead, the electromagnetic actuator 5 is controlled in closed loop, the signal SC is, for example, the control signal outputted by a controller or regulator of flow rate, speed, pressure or temperature of the fluid crossing the valve 2. The signal SC has a time pattern which defines a desired motion to be imparted to the translator 7. For example, the signal SC is a step signal if the translator 7 is intended to be moved to a certain position between the two end-of-travel positions, or a signal with a more complex time pattern if an accurate kinematic trajectory is intended to be imparted to the translator 7. The SC signal has an amplitude between a maximum value VCmax and a minimum value VCmin, each of which defines a respective end-of-travel position. In other words, the amplitude of the signal SC is equal to the algebraic difference VCmax−VCmin. The values VCmax and VCmin are calculated according to the mechanics and dimensions of the solenoid valve and of the requested performance of the solenoid valve.

The control unit 12 implements the method for controlling the power supply of an electromagnetic actuator, which method is implemented according to the invention and described as follows.

Again with reference to FIG. 2, the control unit 12 generally implements: a signal generating block 14, to generate the signal SR by modulating an oscillating time function with a limited time duration function so that the signal SR has an amplitude envelope E having a certain maximum width VM and a limited time duration; a triggering block 15 to control the signal generating block 14, i.e. to trigger the modulation of the oscillating time function only at each of given level variations of the signal SC; and a summing block 16 to output the signal SI as a sum of signal SC and signal SR.

The maximum width VM of the signal SR is such that the electromagnetic force generated by the coil 9 increases by a quantity either equal to or greater than a static friction force caused by the contact of the translator 7 against the guiding element 10. In other words, the value of the maximum width VM is chosen according to the static friction force which occurs in the contact points between the translator 7 and the guiding element 10. The value of the maximum width VM is also chosen according to the amplitude of the signal SC. Advantageously, the maximum width VM is between 1% and 50% of the amplitude of the signal SC.

The power device 13 generates the electric current signal I by amplifying the signal SI according to a given voltage-current gain GI. Therefore, the maximum width VM of the signal SR and the gain GI is such that the electromagnetic force generated by the coil 9 increases by a quantity either equal to or greater than a static friction force caused by the contact of the translator 7 with the guiding element 10. In the example shown in FIG. 2, the power device 13 comprises an operational amplifier configured as a current amplifier of known type.

According to a further embodiment, the power device 13 comprises a device known as converter or switching amplifier.

Therefore, the control unit 12 causes the signal SR to be activated only at sufficiently wide level variations of the signal SC and the signal SR to be suppressed after a certain time interval in the absence of level variations of the signal SC. Thereby, the translator 7 is prevented from indefinitely and idly oscillating about a desired position defined by the constant value of the SC signal, and thus reducing: losses due to hysteresis and eddy currents in magnetic materials caused by the persistence of an alternating current producing a magnetic induction; wear of the mechanical parts in reciprocal contact and subject to frictions caused by the persistent movement of the translator 7; and additional losses due to Joule effect in the copper conductors of the coil 9 due to the presence of the alternating current component.

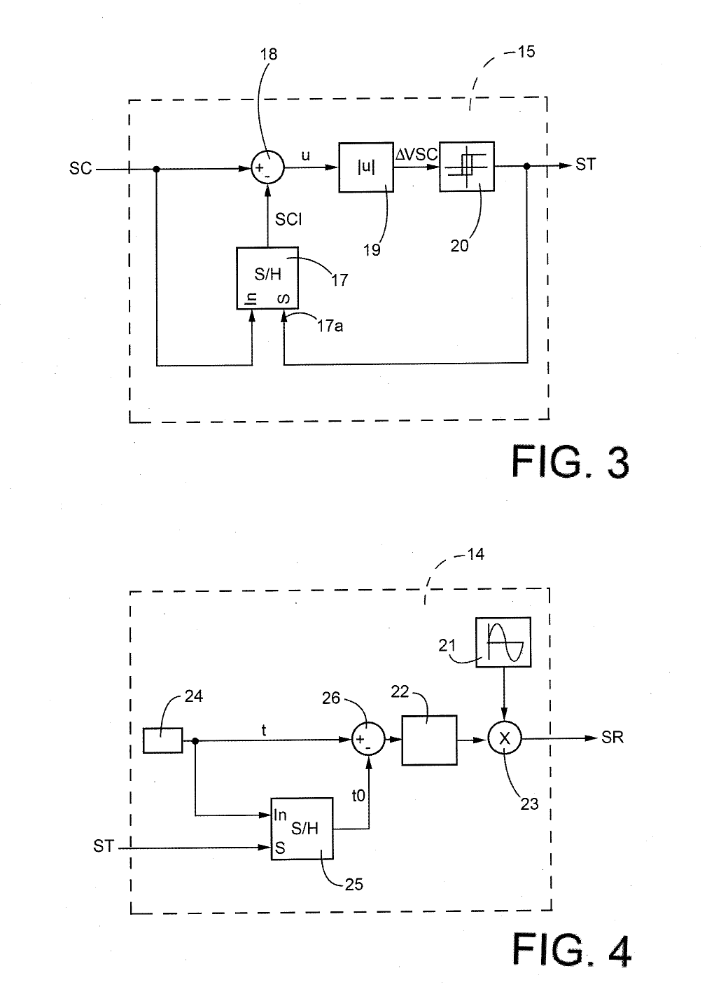

With reference to FIG. 3, the triggering block 15 comprises: a sampling block (“sample and hold”) 17 to acquire and store an initial level sample SCI of the signal SC; a subtracting block 18 to calculate the difference between the current level of the signal SC and the initial level SCI; and a processing block 19 to output the absolute value of the difference calculated by the block 18. The value output by the processing block 19 expresses a level variation of the signal SC with respect to the initial level SCI and is indicated by ΔVSC hereinafter. The blocks 17, 18 and 19 in fact measure the level variation ΔVSC.

The triggering block 15 further comprises a hysteresis comparator block 20 for comparing the level variation ΔVSC with a certain threshold THC and determining a time instant t0 at which the signal generating block 14 needs to be triggered, on the basis of such a comparison. The time instant t0 is the time instant in which the level variation ΔVSC becomes higher, comprising a given hysteresis, of the threshold THC. In other words, the triggering block 15 is adapted to trigger the modulation of the oscillating time function only at those level variations ΔVSC of the signal SC which are higher than the threshold THC.

The threshold THC has a value chosen according to a compromise between high operating sensitivity and suitable filtering of the noise possibly present on the signal SC. In other words, the threshold THC has a value such as to allow the signal generating block 14 to be also triggered for minor level variations of the signal SC, but not for oscillations due to noise superimposed on the signal SC. The threshold has a value either lower than or equal to 1% of the amplitude of the signal SC. Advantageously, the threshold has a value equal to 0.1% of the amplitude of the signal SC.

The output of the comparator block 20 is fed back to the control input 17a of the sampling block 17 to acquire and store a new initial level value SCI and, consequently, reset the level variation ΔVSC. Thereby, the output of the comparator block 20 switches, for example, from a low level to a high level at the time instant t0 and switches back to the low level when the effect of sampling the new initial level SCI propagates up to the comparator block 20. In other words, the comparator block 20 outputs a triggering signal ST with which the signal generating block 14 is controlled. The signal ST comprises at least one pulse defined between the time instant t0 and a subsequent time instant t1, which depends on the total response time of the chain of the blocks 17-20.

From the above description it is apparent that after acquiring a new initial level value SCI, the comparator block 20 outputs a subsequent pulse and, therefore, updates the time instant t0, as soon as the signal SC has a subsequent level variation ΔVSC higher than the threshold THC, the subsequent level variation ΔVSC being calculated with respect to the new initial level value SCI.

FIG. 4 shows an example of implementing the signal generating block 14. According to FIG. 4, the signal generating block 14 comprises: a function generating block 21 to generate the oscillating time function FO; a function generating block 22 to generate the time limited function FD; and a multiplying block 23 to obtain the signal SR by modulating the oscillating function FO with the function FD.

Advantageously, the oscillating function FO is a periodical function. Alternatively, the oscillating function FO is white noise. Advantageously, the oscillating function FO has a zero average value.

The signal generating block 14 further comprises: the time counter block 24, adapted to increase a variable t representing the current time instant; a sampling block 25, for sampling the variable t by means of the signal ST, i.e. at the time instant t0; and a subtracting block 26 for calculating the difference between the variable t and the sample of the variable t at the time instant t0, i.e. in practice for calculating a difference u between the variable t and the time instant t0 (u=t−t0). The difference u is inputted in the function generating block 22, i.e. the difference u is the topic of the function FD. In other words, blocks 24-26 shift the initial time instant of the function FD to the time instant t0, so as to trigger the modulation of the oscillating function FO with the decreasing function FD at instant t0 only.

Hence, the generated signal SR will be of the type

SR(t)=FO(ωt)·FD(t−t0),

where ω is the pulse (angular frequency) at which the oscillating function FO oscillates.

For example, the oscillating function FO is a sinusoidal type function

FO(ωt)=F1·sin(ωt),

or is a function of the type

FO(t)=F1·sign[sin(ωt)].

The function FD is timely limited to a duration Td of sufficiently high value to ensure a breakaway between the translator 7 and the guiding element 10, but sufficiently low to take the electric current signal I to a constant value as soon as possible when the signal SC remains constant over a relatively long time. Therefore, the function FD goes to zero after a duration Td from a level variation ΔVSC of the signal SC. The duration value Td is chosen according to the type of application of the electromagnetic actuator 5. It has been experimentally observed that, for most applications, the duration Td is to be either shorter then or equal to 1 s.

The function FD consists, for example, of a rectangular pulse or of a differently shaped pulse.

The function FD advantageously consists of a decreasing time function, so that the amplitude envelope E decreases from the maximum width VM starting from the level variations ΔVSC of the signal SC. In particular, the function FD is a function decreasing to zero: therefore, the amplitude envelope E decreases from the maximum width VM to zero.

The decreasing function FD consists, for example, of at least one function portion of the decreasing exponential type

$$FD ( t ) = \{ \begin{matrix}0 & t < 0 \\ F 2 \cdot exp ( - \frac{t}{Ts} ) & t \geq 0 ,\end{matrix}$$

or consists of at least one function portion of the linear type decreasing to zero

$$FD ( t ) = \{ \begin{matrix}0 & t < 0 \\ \frac{F 2}{Ts} \cdot [ Ts - t ] & 0 \leq t < Ts \\ 0 & t > Ts .\end{matrix}$$

In both examples, Ts is a damping time of the decreasing function FD and is differently defined according to the type of function, as easily deducible from the examples shown above. Therefore, Ts is also the damping time of the amplitude envelope E of the signal SR.

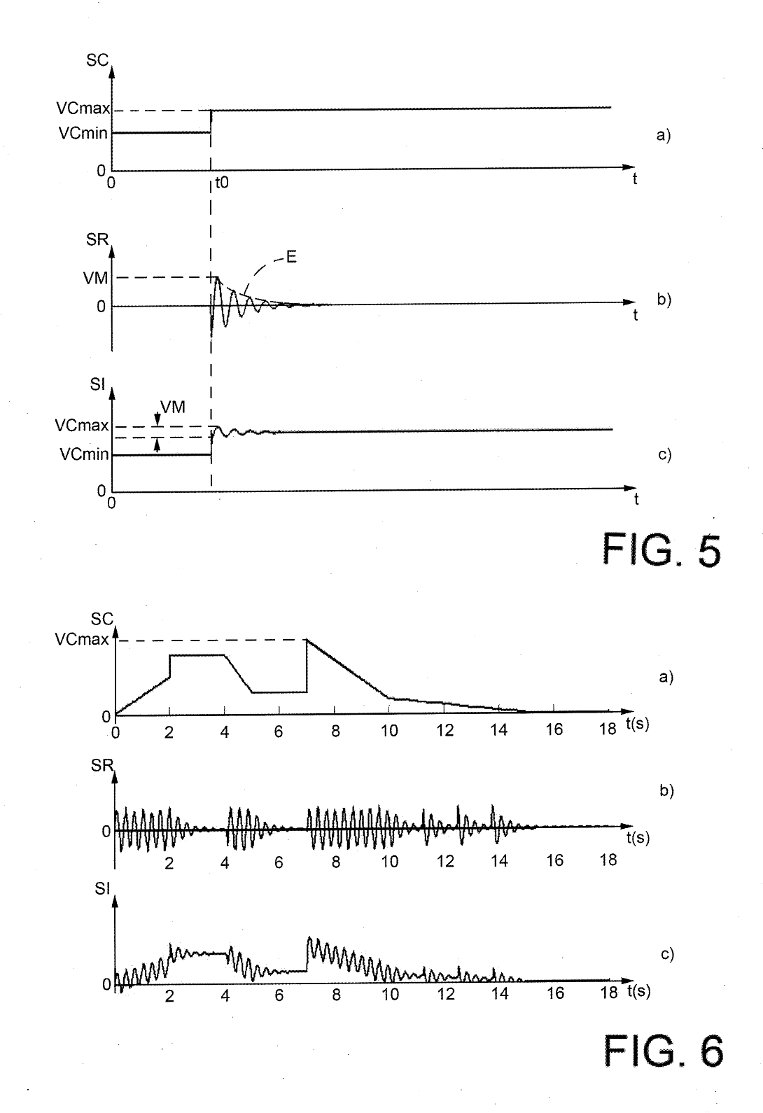

FIG. 5 shows three different charts of the time pattern of signals SC, SR and SI if, for example, the signal SC is a step signal and the function FD is a decreasing exponential function. In such an example, the width of the step coincides with difference VCmax−VCmin (FIG. 5-a). The time instant t0 substantially coincides with the time instant defined by the edge of the step, at which the variation of level ΔVSC quickly becomes equal to the difference VCmax−VCmin, and thus higher than the threshold THC. The decreasing function FD used is a decreasing exponential so that the amplitude envelope E of the signal SR has a decreasing exponential pattern (FIG. 5-b). Therefore, the signal SI has a step time pattern with a superimposed ripple, from the time instant to, of decreasing width VM according to the waveform imposed by the signal SR (FIG. 5-c). As seen in FIG. 5, the signal SC remains constant for a relatively long period of time (longer than the damping step Ts) after the step edge. Therefore, the time instant t0 is not updated, the signal SR evolves undisturbed until it converges to zero and the signal SI converges to the value VCmax. The time pattern of the electric current signal I is not shown because it is substantially the same as the time pattern of the signal SI, minus a scale factor equal to the gain GI of the power device 13.

The purpose of superimposing an oscillating signal SR to the signal SC is to move and maintain the translator 7 at a speed which corresponds to a dynamic friction condition with the guiding element 10. In other words, the oscillating function FO has an oscillating frequency f such as to maintain the translator 7 moving at a speed which corresponds to a dynamic friction condition between the translator 7 and the guiding element 10. The electromagnetic actuator 5, and more generally the solenoid valve 1, has a frequency response of the low-pass type, i.e. the translator 7 is able to follow the signal SC without being attenuated only for frequencies lower than a certain cut-off frequency fc, which depends on the inertia of translator 7 and valve 2, and on the elastic force of spring 8. The oscillating frequency f is thus higher than a frequency band Bfs of the signal SC and lower than a higher frequency fh determined according to the aforesaid cut-off frequency fc. Advantageously, the higher frequency fh has a value between fc/2 and 2·fc.

Damping the oscillation of the signal SR, and thus damping the ripples on the signal SI and on the electric current signal I, principally aims at stopping the translator 7 when it reaches a desired position for a given time, i.e. when the signal SC remains constant over a relatively long time. Thereby, the translator 7 is prevented from indefinitely and idly oscillating about a desired position, thus reducing the wear of the mechanical parts in reciprocal contact, e.g. between the translator 7 and the guiding element 10, and the losses in magnetic materials and conductors due to magnetic flow variations. The damping time Ts has a value such as to take the electric current signal I to a constant value in a reasonable time when the signal SC remains constant over a relatively long time. The damping time value Ts is chosen according to the type of application of the electromagnetic actuator 5. It has been experimentally observed that, for most applications, the damping time Ts is to be lower than or possibly equal to 2 s.

FIG. 6 shows three charts related to the time pattern of signals SC, SR and SI if the signal SC has a time pattern having a series of ramps at a different gradient, alternating in steps and/or periods at constant value. The time scale is in seconds. For illustrative clarity, the oscillation frequency f of the signal SR (FIG. 6-b) is lower than that actually used. As shown in the charts, at the ramps of the signal SC (FIG. 6-a), the threshold THC is repeatedly exceeded by subsequent level variations 66 VSC calculated with respect to respective initial levels SCI of progressively increasing value. This implies a repeated updating of the time instant t0 which does not allow the signal SR to evolve to zero but returns the envelope of the signal SR to the maximum width VM (FIG. 6-b). Therefore, the signal SI has a persistent ripple at the ramps of the signal SC (FIG. 6-c). On the other hand, at the constant value periods of the signal SC, the threshold THC is not exceeded, the time instant t0 is not updated and the signal SR practically evolves to zero before the next ramp or step.

The control unit 12 advantageously comprises a microprocessor (not shown) programmed to implement the various blocks 14-26 described above. For example, with regards to the signal generating block 14, it may be implemented by storing digital samples of the signal SR in a storage and converting these samples into analogue format when generating the signal SR is required. If the power device 13 is of the type comprising a switching power supply, the signal SR is directly used in digital form to generate a PWM (“Pulse Width Modulation”) type signal adapted to control the switching power supply.

Alternately, the microprocessor of the control unit 12 is programmed to implement only some of the functional blocks described above. For example, in a further embodiment of the invention, the function generating block 21 comprises a signal generator of the type consisting of a quartz oscillator.

From the above description, it is further apparent that the above-described method and device for controlling the power supply of an electromagnetic actuator are also applicable to an electromagnetic actuator adapted to produce rotational movements, i.e. of the type comprising a rotor instead of the translator.

The main advantage of the above-described method and device for controlling the power supply of an electromagnetic actuator is to reduce the positioning control error of the translator 7 or of the general movable element of the electromagnetic actuator 5 in response to the signal SC which defines the desired motion of translator 7. Indeed, superimposing the signal SR on the signal SC, which signal SR comprises an oscillation with amplitude envelope decreasing from a certain maximum width at every level variation of a certain entity of the signal SC, allows to overcome the stick-slip between translator 7 and guiding element 10, to maintain the translator 7 moving at a speed corresponding in average to a dynamic friction condition between translator 7 and guiding element 10, and to quickly damp the oscillation of the signal SR when the signal SC remains constant for relatively long periods of time.

1. A method for controlling the power supply of an electromagnetic actuator (5) comprising a stator (6) made of ferromagnetic material, a movable element (7) made of ferromagnetic material and suitable to move along guiding means (10) fixed to the stator (6), and electromagnetic excitation means (9) to generate, when supplied with a determined power supply signal (I), an electromagnetic force (Fem) such as to move the movable element (7); the method comprising:
generating the power supply signal (I) according to a first electric signal (SC) having a time pattern which defines a desired motion for the movable element (7);
the method being characterized in that generating the power supply signal (I) according to the first electric signal (SC) comprises:
generating only at each of determined level variations (ΔVSC) of the first electric signal (SC), a second electric signal (SR) by modulating an oscillating time function (FO) with a time limited function (FD) so that the second electric signal (SR) has an amplitude envelope (E) having a certain maximum width (VM);
generating said power supply signal (I) according to a sum of the first electric signal (SC) and the second electric signal (SR);
said maximum width (VM) of the second electric signal (SR) being such that said electromagnetic force (Fem) is increased by a quantity either equal to or higher than a static friction force (Fa) caused by the contact of said movable element (7) with said guiding means (10).

2. A method according to claim 1, wherein said second electric signal (SR) is only generated at each of the level variations (ΔVSC) of the first electric signal (SC) which are higher than a certain threshold (THC).

3. A method according to claim 1, wherein generating a second electric signal (SR) comprises:
measuring a level variation (ΔVSC) of said first electric signal (SC) with respect to an initial level (SCI) of the first electric signal (SC);
determining a time instant (t0) in which the level variation (ΔVSC) becomes higher than a given threshold (THC); and
at said time instant (t0), triggering the modulation of said oscillating time function (FO) with said time limited function (FD).

4. A method according to claim 3, wherein generating a second electric signal (SC) comprises:
determining a new value of said initial level (SCI) by sampling said first electric signal (SC) at said time instant (t0).

5. A method according to claim 3, wherein measuring a level variation (ΔVSC) of said first electric signal (SC) comprises:
calculating the level variation (ΔVSC) as an absolute value of the difference between the current level of the first electric signal (SC) and said initial level (SCI).

6. A method according to claim 1, wherein said time limited function is a decreasing time function (FD) and said second electric signal (SR) has an amplitude envelope (E) decreasing from said maximum width (VM) starting from each of said level variations (ΔVSC) of the first electric signal (SC).

7. A method according to claim 6, wherein said decreasing time function (FD) consists of at least one portion of a decreasing exponential function.

8. A method according to claim 6, wherein said decreasing time function (FD) is characterized by a damping time either equal to or lower than 2 s.

9. A method according to claim 1, wherein said oscillating time function (FO) is a periodical signal with zero average value.

10. A method according to claim 1, wherein said oscillating time function (FO) has an oscillating frequency (f) such as to maintain said movable element (7) moving at a speed corresponding to a dynamic friction condition between the movable element (7) and said guiding means (10).

11. A method according to claim 10, wherein said oscillation frequency (f) is higher than a frequency band (Bfs) of said first electric signal (SC) and lower than a higher frequency (fh) determined according to a cut-off frequency (fc) of the electromagnetic actuator.

12. A method according to claim 1, wherein generating said power supply signal (I) according to a sum of the first electric signal (SC) with the second electric signal (SR) comprises;
generating a third electric signal (SI) as a sum of the first electric signal (SC) and the second electric signal (SR);
amplifying the third electric signal (SI) according to a determined gain (GI);
said maximum width (VM) of the second electric signal (SR) and said gain (GI) being such that said electromagnetic force (Fem) is increased by a quantity either equal to or higher than a static friction force caused by the contact of said movable element (7) with said guiding means (10).

13. A method according to claim 1, wherein said power supply signal consists of an electric current signal (I).

14. A device for controlling the power supply of an electromagnetic actuator (5); the electromagnetic actuator (5) comprising a stator (6) made of ferromagnetic material, a movable element (7) made of ferromagnetic material and suitable to move along guiding means (10) fixed to the stator (6), and electromagnetic excitation means (9) to generate, when supplied with a determined power supply signal (I), an electromagnetic force (Fem) such as to move the movable element (7); the device (11) being characterized in that it comprises: electronic control means (12) suitable to receive a first electric signal (SC) having a time pattern which defines a desired motion for the movable element (7), to generate a second electric signal (SR) and to provide a third electric signal (SI) generated according to the first electric signal (SC) and to the second electric signal (SR); and amplifying means (13) for generating said electric power supply signal (I) according to an amplification of said third electric signal (SI); said control means (12) being configured to implement the method according to any one of the preceding claims.

15. A device according to claim 14, wherein said amplifying means comprise a current amplifier (13) to generate an electric current signal (I), as a power supply signal.
